(19) United States
(12) Patent Application Publication
(10) Pub. No.: US 2004/0109166 A1
(43) Pub. Date: Jun. 10, 2004

(54) Wavelength Locker With Confocal Cavity

(75) Inventors: John C. Tsai, Saratoga, CA (US); David W. Wang, Saratoga, CA (US); Joseph Methe, San Jose, CA (US)

Correspondence Address: INTELLECTUAL PROPERTY LAW OFFICE, 1901 S. BASCOM AVENUE, SUITE 660, CAMPBELL, CA, 95008, US

(73) Assignee: Fibera, Inc., Santa Clara, CA (US)

(21) Appl. No.: 10/066,000

(22) Filed: Dec. 9, 2002

(51) Int. Cl. G01B 9/02

(52) U.S. Cl. 356/519

(57) ABSTRACT

A wavelength locker having a first beam splitter to receive a light beam and separate out a portion as a sample beam; a confocal etalon to receive the sample beam and filter it into a filterization beam; a filterization photodetector to receive the filterization beam and produce a filterization signal representative of the light intensity in the filterization beam, and thus also of the light frequency in the filterization beam, sample beam, and original light beam; and a link to communicate a control signal, based on the filterization signal, to the light source producing the light beam to lock the wavelength or the frequency.

### BACKGROUND OF INVENTION

1. Technical Field

The present invention relates generally to coherent light generator systems, and more particularly to systems for controlling the wavelength or frequency of light used in such systems. It is anticipated that a primary application of the present invention will be telecommunications, but the invention is also well suited to use in laboratory measurement and other fields.

2. Background Art

The discrete wavelength locker has found wide use in dense wavelength division multiplexed (DWDM) fiber optic communications. With a wavelength locker, variation in laser frequency can be reduced and multiple signal carrying wavelengths can travel through the same optical fiber without cross talk.

Most present wavelength lockers are packaged in stand alone form or in a metal case. To use these devices, a small portion of the laser intensity is tapped with a beam splitter and provided to the wavelength locker via an optical fiber. Unfortunately, this approach, using as it does, the discrete metal case and optical fiber occupy substantial physical space or “footprint” on a printed circuit board and are also expensive.

One method of reducing the footprint and cost of the wavelength locker is to package the optics of the locker together with the laser, that is, embedding the wavelength locker in the laser system it is locking. Doing this and also meeting dimensional constraints, however, is not so straightforward. Recent requirements in the telecommunications industry call for dimensions as small as 4 mm (wide) by 4 mm (high) by 6 mm (long).

In order to shrink wavelength locker optics to smaller dimensions, most prior art designs use a conventional solid etalon 10 such as the one depicted in FIG. 1 (background art). An optical cavity 12 is formed in a solid piece of glass having two very parallel surfaces 14 that are a set space (L) apart. The surfaces 14 are polished to obtain flatness and have dielectric thin film coatings deposited on them to make them semi-reflective and to provide a suitable finesse.

The use of a conventional solid etalon 10 would seemingly help to solve the problems of physical size and cost but, in actuality, it creates new problems. For example, the telecommunications industry also has stringent requirements calling for uniform performance from −45° C. to +80° C., and the index of refraction of glass varies considerably with the temperature of its the ambient environment. Changes in the refractive index of the glass of the solid etalon 10 thus change its wavelength characteristics and, in turn, undermine the frequency stability of the laser it is supposed to be locking.

Of course, measures can be taken to compensate for the variation of the refractive index of glass, even through the wide temperature range needed in telecommunications. A thermal electric cooler (TEC) platform is typically used. However, this exacerbates the engineering effort needed to characterize the interface between the TEC and the glass of the optical cavity 12, it takes up precious space, it generates heat in the printed circuit board, and it increases cost.

FIG. 2 (background art) is a schematic representation of the structural construction and use of a conventional air-spaced etalon 20. A physical and optical cavity 22 is formed between two very parallel surfaces 24 held a set space (L) apart. Like the surfaces 14 of the solid etalon 10, the surfaces 24 here are polished to obtain flatness and are deposited with dielectric thin film coatings to make them semi-reflective and to provide a suitable finesse. Unlike the glass filled optical cavity 12, however, the surfaces 24 here are on plates 26 held apart by spacers 28. The physical and optical cavity 22 thus formed is filled with air (or another gas mixture, or vacuum). This has the advantage of providing temperature stability (it is “athermal”) because the light path between the two reflective surfaces 24 is in air and thus is less affected by temperature changes, and it follows that the wavelength characteristics of the air-spaced etalon 20 are more stable.

A serious disadvantage of the conventional air-spaced etalon 20, however, is that the spacing between the two semi-reflective surfaces 24 needs to be approximately 1.5 times greater than in an equivalent solid etalon. And since, as noted, at least one industry presently requires an overall length of 6 mm, including other components, some important applications have dimensional constraints that are difficult or impossible to meet using the conventional air-spaced etalon 20.

Accordingly, a new type of wavelength locker is needed. In particular, such a new type of locker should have a small footprint, have athermal characteristics, and be low in cost. Such a new type of wavelength locker should also be easily embedded in a lasers or larger system employing them, especially including those used in the fiber optic communications industry.

### SUMMARY OF INVENTION

Accordingly, it is an object of the present invention to provide a wavelength locker able to occupy a small space or small footprint.

Another object of the invention is to provide a wavelength locker having athermal characteristics.

And another object of the invention is to provide a wavelength locker than can be integrated with or embedded into light sources or larger system employing the light source and the wavelength locker.

Briefly, one preferred embodiment of the present invention is an apparatus for locking the wavelength or frequency of a light beam produced by a light source. A first beam splitter receives the light beam and separates out a portion as a sample beam. A confocal etalon receives the sample beam and filters it into a filterization beam. A filterization photodetector receives the filterization beam and produces a filterization signal that is representative of the light intensity in the filterization beam, and thus also of the light frequency in the filterization beam, the sample beam, and the original light beam. A link then communicates a control signal, based on the filterization signal, to the light source to lock the wavelength or the frequency of the light beam.

Briefly, another preferred embodiment of the present invention is a method of locking the wavelength or frequency of a light beam produced by a light source. A sample beam is separated out from the light beam, then filtered through a confocal etalon into a filterization beam. The light intensity in the filterization beam is detected and a filterization signal is produced based on the light intensity in the filterization beam, wherein the filterization signal is representative of the light frequency in the filterization beam and thus also in the light beam. A control signal, based on the filterization signal, is then communicated to the light source to lock the wavelength or the frequency of the light beam.

Briefly, one preferred embodiment of the present invention is an improved apparatus for locking the wavelength or frequency of a light beam produced by a light source. The apparatus is of the type in which an air-spaced etalon filters a sample beam that has been separated out from the light beam. The improvement comprises the air-spaced etalon being a confocal etalon.

Advantages of the present invention include its potential compactness, thermal stability, and suitability for integration with or embedding in light sources or larger systems employing the light source and the invention.

And another advantage of the invention is its economy. It uses largely conventional components and techniques, although in novel manner. It may also, in some embodiments, employ industry standard components or elements derived relatively easily from industry standard components.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

The purposes and advantages of the present invention will be apparent from the following detailed description in conjunction with the appended figures of drawings in which:

FIG. 1 (background art) is schematic representation of the structure and use of a conventional solid etalon;

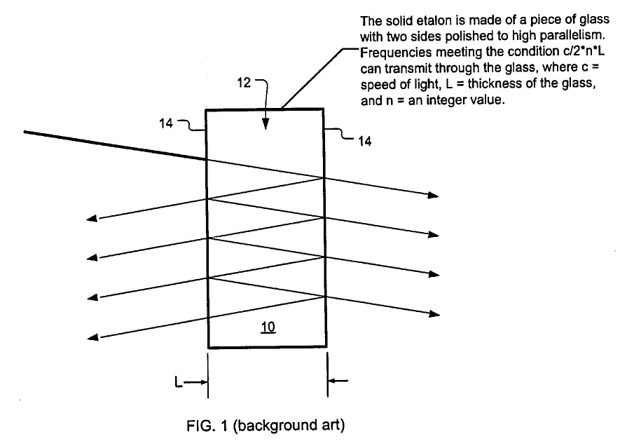

FIG. 2 (background art) is a schematic representation of the structure and use of a conventional air-spaced etalon;

FIG. 3 is a schematic block diagram of the structure and use of a wavelength locker according to the present invention; and

FIG. 4 is a schematic representation of the structure and use of the confocal etalon of the wavelength locker in FIG. 3.

In the various figures of the drawings, like references are used to denote like or similar elements or steps.

### DETAILED DESCRIPTION

### BEST MODE FOR CARRYING OUT THE INVENTION

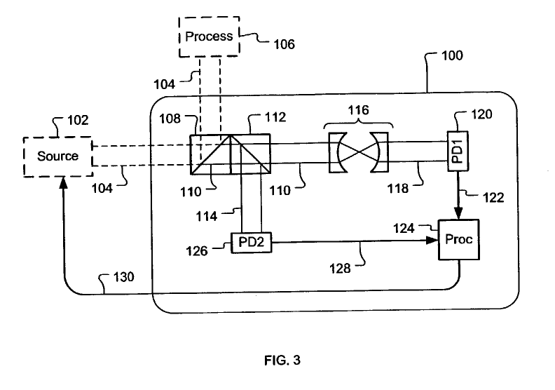

A preferred embodiment of the present invention is a frequency or wavelength locker employing a confocal cavity. As illustrated in the various drawings herein, and particularly in the view of FIG. 3, the preferred embodiment of the invention is depicted by the general reference character 100.

FIG. 3 is a schematic block diagram depicting the structure and use of a wavelength locker 100 according to the present invention. A light source 102 provides a light beam 104 that passes through the wavelength locker 100 to a process 106, for use there. Since the light source 102, light beam 104, and process 106 are not formally parts of the present invention, and act more in the nature of a workpiece upon which or within which the invention works, they are represented in ghost outline in FIG. 3.

As the light beam 104 passes through the wavelength locker 100 it encounters a first beam splitter 108, where a sample beam 110 is diverted from the light beam 104. Typically, but not necessarily, the first beam splitter 108 is constructed such that the sample beam 110 has less intensity than the portion of the light beam 104 that is provided to the process 106. In the embodiment shown, the sample beam 110 is received by a second beam splitter 112 and a normalization beam 114 is also separated out. The sample beam 110 then continues to and passes through a confocal etalon 116, producing a filterization beam 118. The filterization beam 118, in turn, is received by a filterization photodetector 120 (“PD1”) and a filterization signal 122 is produced that is communicated to a processor 124 (“Proc”). The normalization beam 114 is received by a normalization photodetector 126 (“PD2”), and a normalization signal 128 is produced that is also communicated to the processor 124. The processor 124 then produces a control signal 130 that is communicated to the light source 102, for use there to control the frequency of the light beam 104 as it is being provided.

The confocal etalon 116 is the key component in the present invention. It filters the sample beam 110 so that the resulting filterization beam 118 has a light intensity that is dependent on the light wavelengths present and the characteristics of the confocal etalon 116, discussed in detail presently. This may not, however, be the only factor effecting light intensity. For example, changes at the light source 102 may cause the intensity of the original light beam 104 to vary, or the intensity of the light beam 104 or the sample beam 110 may be effected in some other manner. It therefore may be desirable to normalize the filterization signal 122 when producing the control signal 130. The normalization beam 114 is used for this, in essentially the same manner that may optical system perform light intensity normalization.

The embodiment of the wavelength locker 100 depicted in FIG. 3 is a relatively complex one, chosen for use here for its exemplary value, and once the concepts presented here are grasped, those skilled in the art will appreciate that many other embodiments, including simpler ones, may be constructed yet still remain true to the spirit of the invention. For instance, normalization may not be provided by the wavelength locker 100. The light source 102 can be made highly stable with respect to intensity so that normalization is dispensed with, or another intensity stabilizing means can be employed. When this is done, the second beam splitter 112, the normalization beam 114, the normalization photodetector 126, the normalization signal 128, and the ability in the processor 124 to perform normalization can be omitted. Other embodiments can, for example, communicate the filterization signal 122 and normalization signal 128, if the latter is even present, directly to the light source 102. That is, the processor 124 can be eliminated by integrating its role into another control system that is present. Since the inventive wavelength locker 100 is highly suitable for embedding into assemblies with the light source 102, or even into assembles where the light source 102 and the process 106 are integrated together, the inventors expect that many embodiments of the wavelength locker 100 will not need to have a separate processor 124.

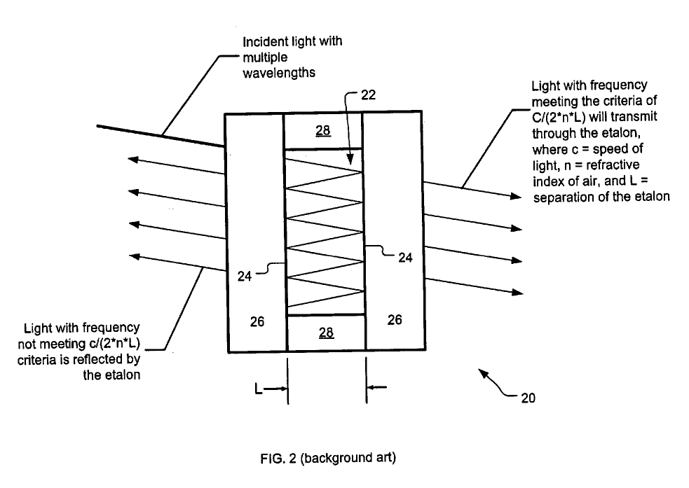

With reference again to FIG. 2 (background art) it can be appreciated that the wavelength locker 100 is conventional in many respects. It is particularly novel, however, with respect to its use of the confocal etalon 116. While confocal optical cavities are known and have, for example, long been employed for beam stabilization within laser resonators, they have not been used until now in frequency or wavelength locking systems.

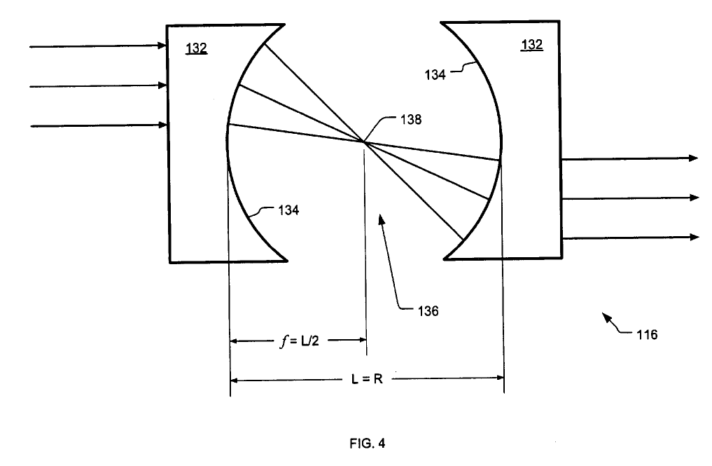

FIG. 4 is a schematic representation depicting the structure and use of the confocal etalon 116 in the inventive wavelength locker 10. The confocal etalon 116 has two plates 132 that each have a curved, semi-mirrored or semi-reflective surface 134. The plates 132 are placed in an opposed arrangement such that the surfaces 134 define a confocal cavity 136 and share a common focus 138. The curvatures of the surfaces 134 may be spherical or parabolic, and this may be in three physical dimensions or just two. For example, for the three dimensional case the common focus 138 in FIG. 4 would be a single point and for the two dimensional, or “cylindrical,” case the common focus 138 would be an axis extending perpendicular to the page.

As is the case generally for so-called “air-spaced” etalons, the confocal cavity 136 of the confocal etalon 116 may be filled with air, another gas mixture, a single gas (e.g., Nitrogen), or even vacuum. In fact, the salient feature of so-called air-spaced etalons and the confocal etalon 116 is merely a high disparity in the refractive indexes of the optical materials used.

FIG. 4 further depicts how the spherical surfaces 134 are placed apart a distance, L, wherein L equals the radius of the resulting spherical confocal cavity 136. The common focus 138 thus is a distance L/2 from each surface 134 and the free spectral range (FSR) is provided by the formula FSR=c/(4*n*L), where c is the speed of light and n is the refractive index of air between the two semi-reflecting surfaces.

An optical cavity constructed in this way is a confocal interferometer and its FSR is one-half that of a plane-plane mirror defined cavity. This means that, for the same FSR, the confocal cavity 136 in the inventive wavelength locker 100 requires a spacing between its surfaces 134 that is only one-half the spacing of the reflective surfaces in a conventional air-spaced etalon (e.g., the surfaces 24 in the conventional air-spaced etalon 20 in FIG. 2).

For the 50 GHz ITU grid communications channel, the spacing between surfaces in an air-spaced plane-plane etalon (e.g., air-spaced etalon 20) would be 3 mm; and for the 25 GHz ITU grid, this spacing would be 6 mm. In contrast, these values can be reduced to 1.5 mm and 3 mm, respectfully, when the confocal etalon 116 of the inventive wavelength locker 100 is used. Accordingly, the wavelength locker 100 can be constructed much more compactly, can be more easily integrated or embedded into systems employing it, and can meet the 6 mm physical length requirement of the telecommunications industry.

Furthermore, since the confocal cavity 136 allows the light to propagate in air between the two surfaces 134, the athermal property of an air-spaced system is preserved. This eliminates the need for a thermal electric cooler (TEC) or other thermal stabilization mechanism, as well as eliminating systems to set-up, operate, and maintain such a mechanism. Yet further, any additional cost for the plates 132 can be nominal, since reflectors with these curvatures, and thus potentially suitable for use for the surfaces 134, are commonly used in other optical applications.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The wavelength locker 100 is well suited for application in industry today. As has been described, it may be constructed in highly compact form. This facilitates the invention's use generally, since minimizing space or “footprint” is often a concern, and it especially facilitates embedding the invention directly into the laser system it is locking or the larger system employing the laser. And as has been emphasized, the invention is particularly suitable for meeting the stringent space and thermal requirements of the telecommunications industry.

Furthermore, the wavelength locker 100 is highly flexible in its range of potential embodiments. As has been noted, embodiments can be constructed that integrate sophisticated features such as light intensity normalization, and embodiments can be constructed that reduce overall component count by integrating signal processing and communications needs of the wavelength locker 100 into the processing and control circuitry of the light source or process employing the locker and light source.

Yet further, the wavelength locker 100 is economical and its benefits are currently realizable and desired. The wavelength locker 100 can be constructed of largely conventional components, although in novel manner, and in some cases standard optical industry components may be employed or adapted for use in the invention. The invention also employs largely conventional techniques, although also in novel manner, and once the teaching herein are grasped by those of reasonable skill, it is a relatively straight forward exercise to design and construct embodiments of the invention. Finally, the telecommunications industry has been cited herein as one where the capabilities of the wavelength locker 100 are already in critical need.

For the above, and other, reasons, it is expected that the wavelength locker 100 of the present invention will have widespread industrial applicability. Therefore, it is expected that the commercial utility of the present invention will be extensive and long lasting.

1. An apparatus for locking the wavelength or frequency of a light beam produced by a light source, comprising:
a first beam splitter to receive the light beam and separate out a portion therefrom as a sample beam;
a confocal etalon to receive said sample beam and filter said sample beam into a filterization beam;
a filterization photodetector to receive said filterization beam and produce a filterization signal based thereon that is representative of light intensity in said filterization beam and thus also of light frequency in said filterization beam, in said sample beam, and in the light beam; and
a link to communicate said filterization signal to the light source as a control signal to lock the wavelength or the frequency of the light beam.

2. The apparatus of claim 1, wherein said confocal etalon includes two plates having opposed, semi-reflective surfaces that are two dimensionally spherical or parabolic, thereby being cylindrical instances of said semi-reflective surfaces.

3. The apparatus of claim 1, wherein said confocal etalon includes two plates having opposed, semi-reflective surfaces that are three dimensionally spherical or parabolic, thereby being concave instances of said semi-reflective surfaces.

4. The apparatus of claim 1, wherein said link is a control link, and the apparatus further comprising:
a signal link to communicate said filterization signal to a processor; and
said processor, to process said filterization signal into said control signal before communication to the light source via said control link.

5. The apparatus of claim 1, wherein said link is a control link, and the apparatus further comprising:
a second beam splitter to also receive said sample beam and separate out a portion therefrom as a normalization beam;
a normalization photodetector to receive said normalization beam and produce a normalization signal based thereon that is representative of light intensity in said normalization beam;
a filterization link to communicate said filterization signal to a processor;
a normalization link to communicate said normalization signal to said processor; and
said processor, to process said filterization signal, with normalization based on said normalization signal, into said control signal before communication to the light source via said control link.

6. A method of locking the wavelength or frequency of a light beam produced by a light source, comprising:
separating out a sample beam from the light beam;
filtering said sample beam through a confocal etalon into a filterization beam;
detecting light intensity in said filterization beam;
producing a filterization signal based on said light intensity in said filterization beam, wherein said filterization signal is representative of light frequency in said filterization beam and thus also the light beam; and
communicating said filterization signal as a control signal to the light source, to lock the wavelength or the frequency of the light beam.

7. The method of claim 6, further comprising:
separating our a normalization beam from said sample beam;
detecting light intensity in said normalization beam;
producing a normalization signal based on said light intensity in said normalization beam; and
communicating said filterization signal and said normalization signal as said control signal to the light source, to lock the wavelength or the frequency of the light beam.

8. The method of claim 6, further comprising processing said filterization signal into said control signal such that said control signal is suitable for directing the light source to change the wavelength or frequency of the light beam being produced.

9. The method of claim 8, further comprising:
separating our a normalization beam from said sample beam;
detecting light intensity in said normalization beam;
producing a normalization signal based on said light intensity in said normalization beam; and
processing said filterization signal into said control signal based on said normalization signal.

10. The method of claim 6, wherein said confocal etalon includes two plates having opposed, semi-reflective surfaces that are two dimensionally spherical or parabolic, thereby being cylindrical instances of said semi-reflective surfaces.

11. The method of claim 6, wherein said confocal etalon includes two plates having opposed, semi-reflective surfaces that are three dimensionally spherical or parabolic, thereby being concave instances of said semi-reflective surfaces.

12. An improved apparatus for locking the wavelength or frequency of a light beam produced by a light source, of the type in which an air-spaced etalon filters a sample beam that has been separated out from the light beam, the improvement comprising said air-spaced etalon being a confocal etalon.

13. The improved apparatus of claim 12, wherein said confocal etalon includes two plates having opposed, semi-reflective surfaces that are two dimensionally spherical or parabolic, thereby being cylindrical instances of said semi-reflective surfaces.

14. The improved apparatus of claim 12, wherein said confocal etalon includes two plates having opposed, semi-reflective surfaces that are three dimensionally spherical or parabolic, thereby being concave instances of said semi-reflective surfaces.
